(19) United States
(12) Patent Application Publication
(10) Pub. No.: US 2026/0268637 A1
(43) Pub. Date: Sep. 10, 2026

(54) MULTIMODAL INFORMATION-BASED CLUSTERING METHOD, SERVER, AND STORAGE MEDIUM

(71) Applicant: CLOUD INTELLIGENCE ASSETS HOLDING (SINGAPORE) PRIVATE LIMITED, Singapore (SG)

(72) Inventors: Junlong LIU, Beijing (CN); Chen SHEN, Hangzhou (CN); Zheng WANG, Beijing (CN)

(21) Appl. No.: 19/162,910

(22) PCT Filed: Apr. 17, 2024
(86) PCT No.: PCT/CN2024/088374

§ 371 Date: Sep. 5, 2025

(30) Foreign Application Priority Data
May 5, 2023 (CN) 202310516381.8

(51) Int. Cl. G06V 10/762; G06V 10/74; G06V 10/77

(52) U.S. Cl. CPC G06V 10/762; G06V 10/761; G06V 10/77

(57) ABSTRACT

This application provides a multimodal information-based clustering method, a server, and a storage medium. According to the method, a posterior matching probability function in each single modality is generated through self-learning according to multimodal feature information of to-be-clustered target objects; a posterior matching probability of any two target objects in multimodality is calculated according to the posterior matching probability function in each single modality; and the target objects are clustered according to the posterior matching probability of any two target objects in multimodality to obtain a clustering result. The posterior matching probability that the target objects belong to a same cluster is calculated based on the multimodal feature information of the target objects by using the posterior matching probability function generated through self-learning, and is used as a metric distance for the similarity between the target objects. Clustering is performed based on the posterior matching probability between the target objects.

### CROSS-REFERENCE TO RELATED APPLICATION

This application is a National Stage of International Application No. PCT/CN2024/088374, filed on Apr. 17, 2024, which claims priority to Chinese Patent Application No. 202310516381.8, filed with the China National Intellectual Property Administration on May 5, 2023 and entitled “MULTIMODAL INFORMATION-BASED CLUSTERING METHOD, SERVER, AND STORAGE MEDIUM”. These applications are incorporated herein by reference in their entireties.

### TECHNICAL FIELD

This application relates to the field of computer technologies, and in particular, to a multimodal information-based clustering method, a server, and a storage medium.

### BACKGROUND

With the development of cloud computing and mobile Internet, service platforms generate massive data. The data is missing multimodality. Different objects include data in different modalities, and different modalities have different attributes. It is very important to eliminate redundancy between modalities by using complementarity between the modalities, to learn better feature attributes. Clustering is one of important applications.

Currently, mainstream multimodal clustering methods usually perform clustering based on a Euclidean distance or a cosine similarity between features, and the accuracy and recall rate of clustering are low.

### SUMMARY

This application provides a multimodal information-based clustering method, a server, and a storage medium, to resolve problems of low clustering accuracy and low recall rate of the mainstream multimodal clustering methods.

According to a first aspect, this application provides a multimodal information-based clustering method, including: obtaining multimodal feature information of to-be-clustered target objects; generating a posterior matching probability function in each modality through self-learning according to the multimodal feature information of the target objects; calculating a posterior matching probability of any two target objects in multimodality according to the posterior matching probability function in each modality; and clustering the target objects according to the posterior matching probability of any two target objects in multimodality to generate a clustering result of the target objects.

According to a second aspect, this application provides a multimodal information-based clustering method, including: obtaining multimodal feature information of to-be-clustered images, where the multimodal feature information includes geographic location information and feature information of an included object in at least one modality; generating a posterior matching probability function in each modality through self-learning according to the multimodal feature information of the images; calculating a posterior matching probability of any two images in multimodality according to the posterior matching probability function in each modality, where the posterior matching probability of two images in multimodality is a probability that the two images include a same object; and clustering images including a same object into one category according to the posterior matching probability of any two images in multimodality to obtain a clustering result of the images.

According to a third aspect, this application provides a multimodal information-based clustering method, applied to a terminal side device, and including: obtaining multimodal feature information of to-be-clustered target objects; sending the multimodal feature information of the to-be-clustered target objects to a server; receiving a clustering result of the target objects sent by the server, where the clustering result of the target objects is generated by using the method according to the first aspect; and executing at least one of the following processing logics according to the clustering result: information pushing, information searching, and data classification.

According to a fourth aspect, this application provides a server, including a processor and a memory communicatively connected to the processor. The memory stores computer-executable instructions. The processor executes the computer-executable instructions stored in the memory to implement the method according to the first aspect or the second aspect.

According to a fifth aspect, this application provides a computer-readable storage medium. The computer-readable storage medium has computer-executable instructions stored therein. The computer-executable instructions, when being executed by a processor, are used for implementing the method according to the first aspect or the second aspect.

### BRIEF DESCRIPTION OF DRAWINGS

Accompanying drawings herein are incorporated into the specification and constitute a part of this specification, show embodiments that conform to this application, and are used for describing a principle of this application together with this specification.

FIG. 1 is an architectural diagram of an exemplary multimodal information-based clustering system to which this application is applicable.

FIG. 2 is a flowchart of a multimodal information-based clustering method according to an exemplary embodiment of this application.

FIG. 3 is a flowchart of a multimodal information-based clustering method according to another exemplary embodiment of this application.

FIG. 4 is a framework diagram of determining a posterior matching probability of target objects in multimodality based on multimodal information according to an exemplary embodiment of this application.

FIG. 5 is a flowchart of a multimodal information-based clustering method according to another exemplary embodiment of this application.

FIG. 6 is an interaction diagram of a multimodal information-based clustering method according to an exemplary embodiment of this application.

FIG. 7 is a schematic structural diagram of a multimodal information-based clustering apparatus according to an exemplary embodiment of this application.

FIG. 8 is a schematic structural diagram of a server according to an embodiment of this application.

The foregoing accompanying drawings have shown explicit embodiments of this application, and more detailed descriptions are provided below. These accompanying drawings and text descriptions are not intended to limit the scope of concept of this application, but to describe the concept of this application for a person skilled in the art with reference to specific embodiments.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations that are consistent with this application. On the contrary, the implementations are merely examples of apparatuses and methods that are described in detail in the appended claims and that are consistent with some aspects of this application.

Terms in this application are first interpreted.

Modality: Each type of source or form of information may be referred to as a modality. For example, people have touch, auditory, visual, olfactory, and gustatory senses, which may be used as a plurality of different modalities. Information media include voice, video, text, and the like, and different media may be used as a plurality of different modalities. There are various sensors, such as radar, infrared, and accelerometer, and different source devices may be used as different modalities. For example, multimodal feature information of a person may include visual information such as various biological features, basic profile information, and geographical information such as time and space. In an e-commerce scenario, multimodal feature information of an item may include an image feature, a text description, an item category, sales volume information, comment information, and the like.

Clustering: A process in which a set of physical or abstract objects is divided into a plurality of clusters formed by similar objects is referred to as clustering. A cluster generated through clustering is a set of a group of objects. These objects and objects in the same cluster are similar to each other, and are different from objects in another cluster.

Multimodal clustering: Clustering objects having multimodal information. In an example scenario, images of a same object among images acquired in a plurality of different regions are aggregated into a same category based on multimodal information of the clustered objects. In an e-commerce scenario, items in different shops are aggregated into a same category according to an item uniqueness dimension based on multimodal information of the items.

Missing multimodal: Information in one or more modalities is missing for some objects in an object set having multimodal information. For example, some objects do not have associated persons, and some items do not have associated comment information.

Euclidean distance: A distance between two points in Euclidean space.

Cosine similarity: A similarity between two vectors is measured by calculating a cosine value of an included angle of the two vectors.

Matching probability: A probability that two objects belong to a same clustering category (cluster).

Conditionally independent: If P(X, Y|Z)=P(X|Z) P(Y|Z), or equivalently, P(X|Y, Z)=P(X|Z), it means that events X and Y are conditionally independent for a given event Z. In other words, when Z occurs, whether X occurs is irrelevant to whether Y occurs. In this embodiment, multiple modalities need to be conditionally independent for a given category label and a defined scenario. For example, similarities of different biological feature are conditionally independent given whether it is a same person, and a biological feature similarity and a spatial distance are conditionally independent given whether it is a same person.

Posterior matching probability in a single modality: A posterior matching probability determined based on single-modal feature information of objects.

Posterior matching probability in multimodality: A posterior matching probability between objects determined based on multimodal feature information of the objects.

Posterior matching probability function in a single modality: A posterior matching probability function based on single-modal feature information.

Posterior matching probability function in multimodality: A posterior matching probability function based on multimodal feature information of objects, including a cross posterior matching probability function in two modalities and a mixed posterior matching probability function of three or more modalities.

With the development of cloud computing and the mobile Internet, service platforms generate massive data. For example, large-scale short video data that is photographed and uploaded by mobile terminals, and online clustering is performed by obtaining multimodal information such as video content or images, sounds, and texts, which may be applied to application scenarios such as clustering and retrieval of videos of a same type. For another example, expression manners of people on social networks become more and more abundant. People may express their emotions and opinions by using pictures, texts, videos, and the like. Multimodal information such as pictures, videos, and texts is utilized for dynamic content clustering, dynamic emotion clustering, and the like on social networks to recommend similar dynamic content to users. For another example, an increasing quantity of shopping platforms can provide search services. Different merchants in the shopping platforms have multimodal information such as different descriptions of videos, pictures, texts, prices and the like for items of a same type. Through multimodal information clustering, similar items of from different merchants are clustered together, and a search service combining videos, pictures, and texts can be provided for the users.

Currently, mainstream multimodal clustering methods usually perform clustering based on a Euclidean distance or a cosine similarity between features, and accuracy and a recall rate of clustering are low. In some multimodal clustering methods, a Euclidean distance or a cosine similarity of a key feature is used as a similarity between objects, and feature information in another modality is used as a rule for optimizing the similarity between the objects. For example, when capturing addresses of two pictures are located in a same street, the similarity is increased by 5%; when capturing addresses of two pictures are located in a same region, the similarity is increased by 2%; or the like. Rule setting is not flexible enough, and a clustering effect is affected.

To resolve the problem that the accuracy and recall rate of clustering are low in the current mainstream multimodal clustering methods, this application provides a multimodal information-based clustering method. In this method, a posterior matching probability function in each single modality is generated through self-learning according to multimodal feature information of to-be-clustered target objects, so that the posterior matching probability function in each modality can be automatically learned without using annotation information; a posterior matching probability of any two target objects in multimodality is calculated according to the posterior matching probability function in each single modality; and the target objects are clustered according to the posterior matching probability of any two target objects in multimodality to generate a clustering result of the target objects. The posterior matching probability that the target objects belong to a same cluster is calculated based on the multimodal feature information of the target objects by using the posterior matching probability function generated through self-learning, and is used as a metric distance for the similarity between the target objects. In comparison with using the Euclidean distance or the cosine similarity between features in the mainstream methods, using the posterior matching probability between the target objects can measure the similarity between the target objects more accurately. Clustering is performed based on the posterior matching probability between the target objects, which can greatly improve the accuracy and recall rate of the clustering.

The multimodal information-based clustering method provided in this application can generate the posterior matching probability function in each single modality through self-learning, and thereby can be quickly applied to different data distribution scenarios in an unbiased manner, for example, aggregation and collation of picture libraries of different regions and clustering of similar commodities.

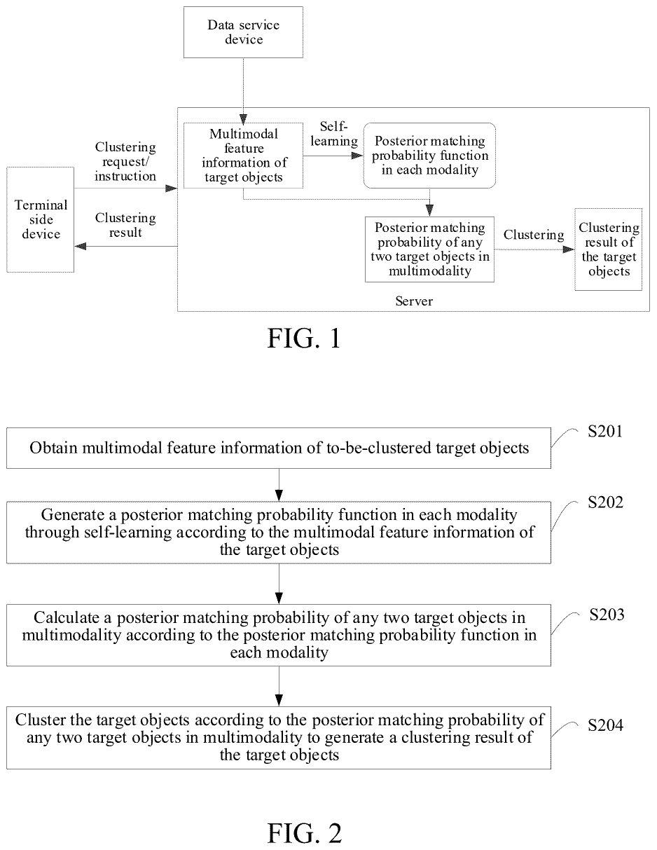

FIG. 1 is an architectural diagram of an exemplary multimodal information-based clustering system to which this application is applicable. As shown in FIG. 1, the system architecture may specifically include a server, a terminal side device, and a data service device.

The server may be specifically a server locally deployed, or may be a server cluster deployed in a cloud. There is a communicable communication link between the server and each terminal side device, enabling communication connection between the server and each terminal side device.

The terminal side device refers to an electronic device providing multimodal feature information of to-be-clustered target objects to the server, and may be specifically a hardware device having a network communication function, a computing function, and an information display function, including but not limited to, a terminal device such as an intelligent terminal, a tablet computer, or a personal computer used by a user, an Internet of Things device, a server of a service platform or an organization, and the like.

The data service device may be a device that can provide multimodal information for the server. The data service device may be specifically a data collection device, or a server that can collect data in one or more modalities collected by a data collection device. The server may obtain multimodal information of the target objects from one or more data service devices, and perform data preprocessing and feature extraction, to obtain the multimodal feature information of the target objects.

The terminal side device sends a clustering request/instruction for the target objects to the server, or invokes an application programming interface provided by the server, to trigger the server to perform clustering based on the multimodal information of the target objects. In response to the clustering request/instruction for the target object, or the application programming interface being invoked, the server obtains the multimodal information of the to-be-clustered target objects from the one or more data service devices, and generates multimodal feature information of the target objects. The server generates a posterior matching probability function in each modality through self-learning according to the multimodal feature information of the target objects; calculates a posterior matching probability of any two target objects in multimodality according to the posterior matching probability function in each modality; and clusters the target objects according to the posterior matching probability of any two target objects in multimodality, to generate a clustering result of the target objects. The server sends the clustering result to the terminal side device, and the terminal side device may execute at least one of the following processing logics according to the clustering result: information pushing, information searching, and data classification. In another implementation, the server may execute at least one of the following processing logics according to the clustering result: information pushing, information searching, and data classification, and send an execution result to the terminal side device.

In another implementation, the terminal side device may obtain multimodal data of the target objects from the data service device. Data in different modalities may be from different devices. The multimodal data of the target objects is preprocessed to generate the multimodal feature information of the target objects, and the multimodal feature information of the target objects is sent to the server.

A possible application scenario is a scenario of clustering and collating image libraries of different regions. Images that belong to a same object in the images captured in different regions are clustered to a same cluster based on geographic location information of image capturing and feature information that is in at least one modality and of an object included in the images. For example, based on images captured in different regions, multimodal clustering is performed on the images based on geographic location information of image capturing, and attributive features and biometric features of persons included in the images, to aggregate images of a same person to a same cluster. For example, based on motor vehicle images captured in different regions, multimodal clustering is performed on the motor vehicle images based on geographic location information of motor vehicle image capturing, license plate numbers, owner identities, and appearance features of motor vehicles included in the motor vehicle images, and the like, to aggregate images of a same motor vehicle into a same cluster.

In this scenario, the to-be-clustered target objects are images, and the server may be a server of a system platform that has an information library aggregation and collation requirement and has authorization, and may be specifically a server deployed on a local or cloud platform. The server obtains to-be-clustered images and geographic location information of the images from inside the system platform or from an image capturing device for which the system platform has data authorization, recognizes objects included in the images by using an image recognition technology, and obtains feature information in at least one modality of the included objects, to obtain multimodal feature information of the to-be-clustered images. The server generates a posterior matching probability function in each modality through self-learning according to the multimodal feature information of the images; calculates a posterior matching probability of any two images in multimodality according to the posterior matching probability function in each modality, where the posterior matching probability of the two images in multimodality is a probability that the two images include a same object; and clusters images including a same object into one category according to the posterior matching probability of any two images in multimodality to obtain a clustering result of the images. For example, according to a clustering result, in accordance with clusters to which the images belong, the server associates images of a same cluster with an included object and stores the images by classification to implement the function of information library aggregation and collation. The to-be-clustered information in the information library may be images, audios, or another type of data information, which is not specifically limited herein.

Another possible application scenario is an e-commerce scenario. Different merchants on an e-commerce platform have information in different modalities, such as videos, pictures, introduction texts, and price information, for a same type of items. Similar items from different merchants are clustered to a same cluster through multimodal clustering, to implement services such as item searching and item recommendation based on the multimodal information such as videos, pictures, introduction texts, and price information.

In this scenario, the to-be-clustered target objects are items, and the server may be a server of the e-commerce platform, and may be specifically a server deployed on a local or cloud platform. The server obtains, from within the e-commerce platform, the multimodal information such as videos, pictures, introduction texts, and price information of different merchants for the items, and performs data preprocessing to generate multimodal feature information of the items. The server generates a posterior matching probability function in each modality through self-learning according to the multimodal feature information of the items; calculates a posterior matching probability of any two items in multimodality according to the posterior matching probability function in each modality, where the posterior matching probability of the two items in multimodality is a probability that the two items are of a same type; and clusters items of a same type into one type according to the posterior matching probability of any two items in multimodality to obtain a clustering result. For example, based on the clustering result, the server may associate items that belong to a same cluster, search for similar items according to query information inputted by a user or an item in which the user is currently interested (for example, clicks to browse, adds to cart, or follows), and recommend the similar items to the user.

The method of this embodiment may be specifically applied to scenarios in which clustering needs to be performed in various application fields, including but not limited to fields such as information library aggregation and collation, e-commerce, education, and medical treatment. Abstract objects, such as data objects, and physical objects may be clustered. Types of to-be-clustered target objects and specific application scenarios of clustering results are not specifically limited herein.

The following describes the technical solutions of this application and how the technical solutions of this application resolve the foregoing technical problems in detail by using specific embodiments. The following specific embodiments may be combined with each other, and descriptions of the same or similar concepts or processes may not be repeated in some embodiments. The embodiments of this application will be described below with reference to the accompanying drawings.

FIG. 2 is a flowchart of a multimodal information-based clustering method according to an exemplary embodiment of this application. An executive entity of this embodiment may be the server in the multimodal information-based clustering system architecture mentioned above. The method provided in this embodiment is used for implementing multimodal clustering of target objects based on multimodal feature information of the target objects. As shown in FIG. 2, the method specifically includes the following steps.

Step S201: Obtain multimodal feature information of to-be-clustered target objects.

In this embodiment, to accurately cluster a plurality of to-be-clustered target objects, the server obtains feature information of the target objects in a plurality of different modalities. In different application scenarios, sources and manners for the server to obtain the multimodal feature information may be different.

For example, the server may obtain the multimodal feature information of the target objects from one or more data service devices inside a system platform where the server is located. Feature information in different modalities may be from a same data service device or different data service devices.

For example, the server may also obtain multimodal data of the target objects from one or more data service devices inside a system platform where the server is located, and perform data preprocessing and feature extraction to generate the multimodal feature information of the target objects.

For example, the server may also receive the multimodal feature information of the target objects sent by a terminal side device. The terminal side device may be a device that sends a clustering request/instruction to the server, or invokes a clustering application programming interface provided by the server. The terminal side device may perform data preprocessing and feature extraction on the multimodal data of the target objects provided by one or more data service devices, to obtain the multimodal feature information of the target objects.

The target object is any one of the following: a physical object, an image including a physical object, or a text including a physical object. The multimodal feature information of the target object includes at least one of the following: an image feature, a text feature, an attribute feature, or a geographic location feature.

The multimodal feature information of the target object includes, but is not limited to: attribute information of the target object in one or more modalities (which may include a geographic location feature, a category feature, and the like), a feature of content included by the target object in one or more modalities (which may include an image feature, a text feature, and the like), and a feature of an object associated with the target object in one or more modalities (which may include an image feature, a text feature, an attribute feature, a geographic location feature, and the like).

For example, in an image library aggregation and collation scenario, to-be-clustered target objects may be images, and multimodal feature information of the target objects includes, but is not limited to: geographic location information of image capturing, feature information of an object included in the images in at least one modality, such as a biological feature of a person included in the images, and a license plate number, owner information, and an appearance feature of a motor vehicle included in the images.

For example, in an e-commerce scenario, to-be-clustered target objects may be items, and multimodal feature information of the target objects includes, but is not limited to, videos, images, introduction texts, and price information.

Step S202: Generate a posterior matching probability function in each modality through self-learning according to the multimodal feature information of the target objects.

In this embodiment, the posterior matching probability function in each modality is automatically generated based on the multimodal feature information of the target objects through self-learning. The posterior matching probability function in any modality may be used for calculating, based on feature information of the target objects in the modality, a posterior matching probability that any two target objects belong to a same cluster. The posterior matching probability reflects a similarity between the target objects in the feature information in the current modality.

Step S203: Calculate a posterior matching probability of any two target objects in multimodality according to the posterior matching probability function in each modality.

After the posterior matching probability function in each modality is generated through self-learning, the posterior matching probability of any two target objects in multimodality is calculated and determined based on the posterior matching probability function in each modality and the multimodal feature information of the target objects. This posterior matching probability reflects an overall similarity between the multimodal feature information of the target objects. In comparison with a posterior matching probability calculated based on feature information in a single modality, using the posterior matching probability of different target objects in multimodality is more accurate in measuring the similarity between the target objects.

Step S204: Cluster the target objects according to the posterior matching probability of any two target objects in multimodality to generate a clustering result of the target objects.

After the posterior matching probability of any two target objects in multimodality is obtained, the target objects are clustered based on the posterior matching probability of the any two target objects in multimodality, target objects having a larger posterior matching probability in multimodality are clustered into a same cluster, and target objects having a smaller posterior matching probability in multimodality are clustered into different clusters, thereby implementing accurate clustering of the target objects.

In this step, any existing clustering algorithm may be used, and the posterior matching probability of the target objects in multimodality is used as a metric distance for the similarity between the target objects to perform clustering. A specific clustering procedure is not repeated here.

According to the method in this embodiment, a posterior matching probability function in each single modality is generated through self-learning according to multimodal feature information of to-be-clustered target objects, so that the posterior matching probability function in each modality can be automatically learned without using annotation information; a posterior matching probability of any two target objects in multimodality is calculated according to the posterior matching probability function in each single modality; and the target objects are clustered according to the posterior matching probability of any two target objects in multimodality to generate a clustering result of the target objects. The posterior matching probability that the target objects belong to a same cluster is calculated based on the multimodal feature information of the target objects by using the posterior matching probability function generated through self-learning, and is used as a metric distance for the similarity between the target objects. In comparison with using the Euclidean distance or the cosine similarity between features in mainstream methods, using the posterior matching probability between the target objects can measure the similarity between the target objects more accurately. Clustering is performed based on the posterior matching probability between the target objects, which can greatly improve the accuracy and recall rate of the clustering.

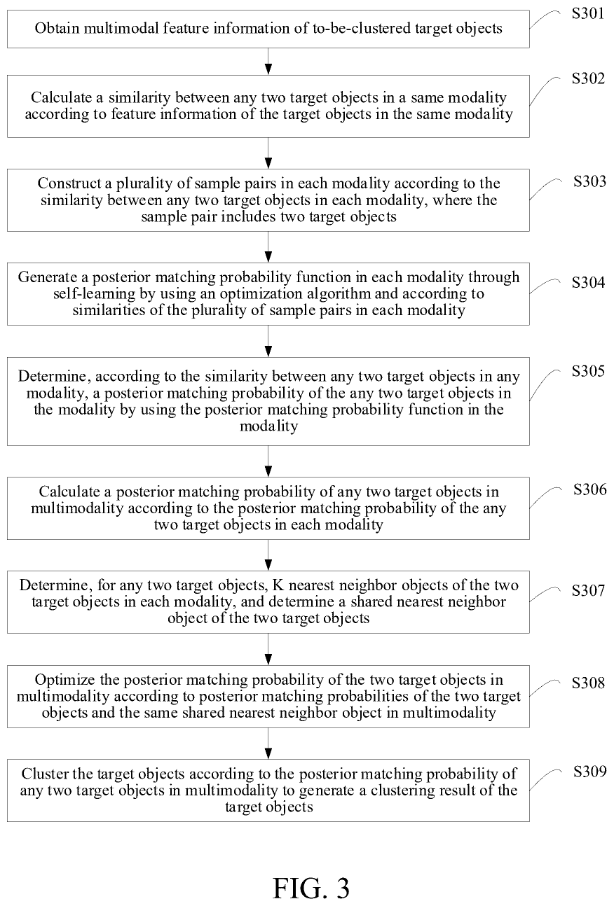

FIG. 3 is a flowchart of a multimodal information-based clustering method according to another exemplary embodiment of this application. Based on the foregoing method embodiments, the multimodal information-based clustering method is described in detail in this embodiment. As shown in FIG. 3, specific steps of the method are as follows.

Step S301: Obtain multimodal feature information of to-be-clustered target objects.

This step is implemented in the same manner as the foregoing step S201, and details are not described here again.

In an embodiment, a server may receive the multimodal feature information of the to-be-clustered target objects sent by a terminal side device. Further, after obtaining a final clustering result of the target objects, the server outputs the clustering result of the target objects to the terminal side device.

After the multimodal feature information of the to-be-clustered target objects is obtained, step S302 to S304 are performed to implement step S202 of generating a posterior matching probability function in each modality through self-learning according to the multimodal feature information of the target objects.

Step S302: Calculate a similarity between any two target objects in a same modality according to feature information of the target objects in the same modality.

Specifically, the feature information of the target objects in each modality may be encoded into a feature vector. Based on feature vectors in any modality, a Euclidean distance or a cosine similarity between feature vectors of any two target objects in the modality is calculated, and is used as a similarity between the any two target objects in the modality.

The similarity between any two target objects in any modality may be stored as a matrix to obtain a similarity matrix in the modality. M is used to represent a quantity of modalities, and similarity matrices in the modalities may be represented as w⁽¹⁾, w⁽²⁾, . . . , and w^{(M)}.

Step S303: Construct a plurality of sample pairs in each modality according to the similarity between any two target objects in each modality, where the sample pair includes two target objects.

In this step, for any modality, a plurality of sample pairs in the modality are constructed based on the similarity between any two target objects in the modality. Sample pairs in each modality are constructed based on the same manner to obtain a plurality of sample pairs in each modality.

In a possible implementation of this step, when a plurality of sample pairs in any modality are constructed, any two target objects may form a sample pair; or two different target objects may be randomly selected to form a sample pair.

In another possible implementation of this step, when a plurality of sample pairs in any modality are constructed, K nearest neighbor objects of each target object in the modality may also be determined according to the similarity between any two target objects in the modality; and any target object separately forms a sample pair with each of the K nearest neighbor objects in this modality to obtain K sample pairs including the target object. A quantity of the target objects is represented as N, and N×K sample pairs in this modality can be obtained. K and N are both positive integers. By constructing high-quality sample pairs in this manner, the quantity of the sample pairs is reduced, and quality and efficiency of generating the posterior matching probability function in each modality through self-learning can be improved.

The K nearest neighbor objects of any target object in the modality are obtained by determining, based on similarities between other target objects and the target object in the modality, K target objects having high similarities with the target object by using a K nearest neighbor (K Nearest Neighbor, KNN for short) algorithm. K may be set and adjusted according to a requirement of an actual application scenario, which is not specifically limited herein.

Step S304: Generate a posterior matching probability function in each modality through self-learning by using an optimization algorithm and according to similarities of the plurality of sample pairs in each modality.

After the plurality of sample pairs in each modality are constructed, a single-modal posterior matching probability function in each modality may be generated through self-learning by using an optimization algorithm and based on the constructed sample pairs and the similarities of the sample pairs. Specifically, this may be implemented in the following steps S3041 to S3044:

Step S3041: Initialize the posterior matching probability function in each modality to a monotonically increasing piecewise function, where the piecewise function includes to-be-solved segment parameters.

In an actual application, as the similarity between the target objects increases, the posterior matching probability between the target objects also increases. In this embodiment, the sample pairs in each modality are sorted according to an ascending order of similarities, and then the sample pairs are divided into I segment sets, where I is a positive integer. T is used to represent a quantity of sample pairs in a single modality, T=N×K, and a quantity of sample pairs included in each segment set is

$$\frac{T}{I} .$$

The single-modal posterior matching probability function in each modality is initialized to a monotonically increasing piecewise function including I segments. M is used to represent a quantity of modalities, and a posterior matching probability function in an m^{th} modality may be represented as the following piecewise function:

$${f}^{( m )} ( x ) : ( {x}_{{i}_{m}}^{( m )} , {f}_{{i}_{m}}^{( m )} ) \qquad ( 1 )$$

$$subject to ( s . t . ) : {x}_{1}^{( m )} < {x}_{2}^{( m )} < … < {x}_{I}^{( m )} ,$$

$${f}_{1}^{( m )} < {f}_{2}^{( m )} < … < {f}_{I}^{( m )} ,$$

$${f}_{1}^{( m )} = 0 , {f}_{I}^{( m )} = 1 ,$$

$$\vert {z}_{{i}_{m}}^{( m )} \vert = length ( {r}_{{i}_{m}}^{( m )} ) = \frac{T}{I}$$

In the formula (1),

$${z}_{{i}_{m}}^{( m )}$$

represents an iₘ^{th} segment set in the m^{th} modality.

$$\vert {z}_{{i}_{m}}^{( m )} \vert$$

represents a quantity of sample pairs included in the iₘ^{th} segment set in the m^{th} modality.

$${r}_{{i}_{m}}^{( m )}$$

represents a set of similarities of sample pairs in the iₘ^{th} segment set

$${z}_{{i}_{m}}^{( m )}$$

in the m^{th} modality.

$$length ( {r}_{{i}_{m}}^{( m )} )$$

represents a quantity of similarity values in

$${r}_{{i}_{m}}^{( m )} . {x}_{{i}_{m}}^{( m )}$$

represents an average value of the similarities of sample pairs in the iₘ^{th} segment set in the m^{th} modality. Because the segment sets are obtained by dividing the sample pairs sorted in the ascending order of similarities,

$${x}_{1}^{( m )} < {x}_{2}^{( m )} < … < {x}_{I}^{( m )}$$

holds.

$${f}_{{i}_{m}}^{( m )}$$

represents a function value of an iₘ^{th} segment of the posterior matching probability function in the m^{th} modality, and is a to-be-solved segment parameter. Since the piecewise function is a monotonically increasing function,

$${f}_{1}^{( m )} < {f}_{2}^{( m )} < … < {f}_{I}^{( m )}$$

holds. The minimum value of the posterior matching probability is 0, and the maximum value is 1, so

$${f}_{1}^{( m )} = 0 and {f}_{I}^{( m )} = 1$$

holds. iₘ∈[1, 2, . . . , I], m∈[1, 2, . . . , M].

The posterior matching probability function in each modality can be initialized to the monotonically increasing piecewise function by using the formula (1). An independent variable of each segment is an average value of similarities of sample pairs in a corresponding segment set, the function value is a to-be-solved segment parameter, and there are M×I to-be-solved segment parameters in total.

It should be noted that, the quantity I of segments of the piecewise function may be set according to an actual application scenario. Different values may be used in different application scenarios, and this is not specifically limited herein. For example, a value of I may be 1000, 200, or the like.

Step S3042: Construct an objective function based on the posterior matching probability function in each modality, where the objective function includes the to-be-solved segment parameters.

In this embodiment, the posterior matching probability function in each modality is the single-modal posterior matching probability function, and a single-modal posterior matching probability function in the m^{th} modality may be represented as

$${Fsingle}_{{i}_{m}}^{( m )} : \qquad ( 2 )$$

$${Fsingle}_{{i}_{m}}^{( m )} = {f}_{{i}_{m}}^{( m )} = {f}^{( m )} ( {x}_{{i}_{m}}^{( m )} )$$

In this step, a posterior matching probability function in multimodality is constructed according to the single-modal posterior matching probability function in each modality.

Specifically, a cross posterior matching probability function of any two modalities may be constructed. A cross posterior matching probability function in the m^{th} modality and a b^{th} modality may be represented as

$$Fcros {s}_{{i}_{m}}^{( m ) - ( b )} : \qquad ( 3 )$$

$$\begin{matrix}{Fcross}_{{i}_{m}}^{( m ) - ( b )} = \frac{1}{\vert {z}_{{i}_{m}}^{( m )} \vert} {\sum }_{x ∈ {r}_{{i}_{m}}^{( m )} , {x}_{{i}_{b}}^{( b )} ∈ {r}_{{i}_{m}}^{( m ) - ( b )}} {f}^{( b )} ( {x}_{{i}_{b}}^{( b )} \vert x ) \\ = \frac{1}{\vert {z}_{{i}_{m}}^{( m )} \vert} {\sum }_{x ∈ {r}_{{i}_{m}}^{( m )} , {x}_{{i}_{b}}^{( b )} ∈ {r}_{{i}_{m}}^{( m ) - ( b )}} {f}_{{i}_{b}}^{( b )}\end{matrix}$$

In the formula (3),

$${r}_{{i}_{m}}^{( m ) - ( b )}$$

represents a set of average values of similarities of sample pairs in segment sets in the b^{th} modality to which the sample pairs in the iₘth segment set in the mth modality belong.

$${x}_{{i}_{b}}^{( b )}$$

is an average value of similarities in

$${r}_{{i}_{m}}^{( m ) - ( b )} .$$

iₘ, i_{b}∈[1, 2, . . . , I]. m, b∈[1, 2, . . . , M]. Meanings of other characters are the same as those in the foregoing content, and details are not described herein again.

Further, for similarities

$$\{ {x}_{{i}_{1}}^{( 1 )} , {x}_{{i}_{2}}^{( 2 )} , … , {x}_{{i}_{M}}^{( M )} \}$$

between feature information of any two target objects in given M modalities, a joint probability distribution function of the M modalities may be represented as:

$$\begin{matrix}Fjoint ( {x}_{{i}_{1}}^{( 1 )} , {x}_{{i}_{2}}^{( 2 )} , … , {x}_{{i}_{M}}^{( M )} ) = \frac{{\prod }_{m = 1}^{M} {f}^{( m )} ( {x}_{{i}_{m}}^{( m )} )}{{\prod }_{m = 1}^{M} {f}^{( m )} ( {x}_{{i}_{m}}^{( m )} ) + {\prod }_{m = 1}^{M} ( 1 - {f}^{( m )} ( {x}_{{i}_{m}}^{( m )} ) )} \\ = \frac{{\prod }_{m = 1}^{M} {f}_{{i}_{m}}^{( m )}}{{\prod }_{m = 1}^{M} {f}_{{i}_{m}}^{( m )} + {\prod }_{m = 1}^{M} ( 1 - {f}_{{i}_{m}}^{( m )} )}\end{matrix} \qquad ( 4 )$$

Further, a posterior matching probability function of the M modalities is constructed, and may be represented as:

$${Fmulti}_{{i}_{m}}^{( m )} = \frac{1}{\vert {z}_{{i}_{m}}^{( m )} \vert} {\sum }_{x ∈ {r}_{{i}_{m}}^{( m )}} Fjoint ( {x}_{{i}_{1}}^{( 1 )} , {x}_{{i}_{2}}^{( 2 )} , … , {x}_{{i}_{M}}^{( M )} \vert x ) \qquad ( 5 )$$

Meanings of characters in the formulas (4) and (5) are the same as those in the foregoing content, and details are not described herein again.

In an actual application, for any set of sample pairs, an average value of probabilities that sample pairs belong to a same category as statistically derived based on one modality should be equal to an average value of probabilities that the sample pairs belong to a same category as statistically derived based on any plurality of modalities, an expected value of which should be equal to a true proportion of sample degrees belonging to a same category. In other words, for a same set of sample pairs, posterior matching probability distributions determined based on a posterior matching probability function of a single modality, based on a cross posterior matching probability function of two modalities, and based on a posterior matching probability function of three or more modalities should be consistent. Based on this, the consistency loss function is constructed according to the posterior matching probability function in each modality and the posterior matching probability function in multimodality.

For example, the following consistency loss function may be constructed:

$${L}_{consistency} = \frac{1}{M} {\sum }_{m} ( \frac{1}{I} {\sum }_{{i}_{m}} D ( {Fsingle}_{{i}_{m}}^{( m )} , {Fmulti}_{{i}_{m}}^{( m )} ) ) + \frac{1}{M} {\sum }_{m} ( \frac{1}{I} {\sum }_{{i}_{m}} {\sum }_{b \neq m} D ( {Fsingle}_{{i}_{m}}^{( m )} , {Fcross}_{{i}_{m}}^{( m ) - ( b )} ) ) \qquad ( 6 )$$

D( ) represents a distance function, which can obtain a Euclidean distance or a cosine similarity. Meanings of other characters are the same as those in the foregoing content, and details are not described herein again.

In the formula (6), because

$${Fsingle}_{{i}_{m}}^{( m )}$$

is constrained by

$${Fmulti}_{{i}_{m}}^{( m )} and {Fcross}_{{i}_{m}}^{( m ) - ( b )} ,$$

it is difficult to learn a consistency loss of the three in the formula (6). Based on

$${Fsingle}_{{i}_{m}}^{( m )} , {Fmulti}_{{i}_{m}}^{( m )} , and {Fcross}_{{i}_{m}}^{( m ) - ( b )} ,$$

a mixed posterior matching probability function is defined as follows:

$${Fmix}_{{i}_{m}}^{( m )} = \sqrt{{Fmulti}_{{i}_{m}}^{( m )} \frac{1}{M} ( {Fsingle}_{{i}_{m}}^{( m )} + {\sum }_{b \neq m} {Fcross}_{{i}_{m}}^{( m ) - ( b )} )} \qquad ( 7 )$$

The mixed posterior matching probability function in the formula (7) is used to constrain values of

$${Fsingle}_{{i}_{m}}^{( m )} and {Fcross}_{{i}_{m}}^{( m ) - ( b )} .$$

Meanings of other characters are the same as those in the foregoing content, and details are not described herein again.

Further, based on the formula (7), the consistency loss function in the formula (6) may be replaced with a consistency loss function in the following formula (8):

$${L}_{consistency} = \frac{1}{M} ( {L}_{consistency 1} + {L}_{consistency 2} ) \qquad ( 8 )$$

$$where {L}_{consistency 1} = \frac{1}{M} {\sum }_{m} ( \frac{1}{I} {\sum }_{{i}_{m}} D ( {Fsingle}_{{i}_{m}}^{( m )} , {Fmax}_{{i}_{m}}^{( m )} ) ) , and$$

$${L}_{consistency 2} = \frac{1}{M} {\sum }_{m} ( \frac{1}{I} {\sum }_{{i}_{m}} {\sum }_{b \neq m} D ( {Fcross}_{{i}_{m}}^{( m ) - ( b )} , {Fmix}_{{i}_{m}}^{( m )} ) ) .$$

L_{consistency1} constrains consistency between the single-modal posterior matching probability function and the mixed posterior matching probability function; and L_{consistency2} constrains consistency between the cross posterior matching probability function of two modalities and the mixed posterior matching probability function.

In an actual application, regardless of the posterior matching probability function of a single modality, the cross posterior matching probability function of two modalities, or the mixed posterior matching probability function, the minimum value thereof is 0, and the maximum value thereof is 1. Based on this, a constraint loss function is constructed.

For example, the following constraint loss function may be constructed:

$${L}_{contraint} = {\sum }_{m} ( {\sum }_{i ∈ {r}_{i}} D ( {Fmulti}_{i}^{( m )} , 0 ) + {\sum }_{j ∈ {r}_{j}} D ( {Fmulti}_{j}^{( m )} , 1 ) ) + {\sum }_{m} ( {\sum }_{i ∈ {r}_{i}} D ( {Fsingle}_{i}^{( m )} , 0 ) + {\sum }_{j ∈ {r}_{j}} D ( {Fsingle}_{j}^{( m )} , 1 ) ) + {\sum }_{m} ( {\sum }_{b \neq m} ( {\sum }_{i ∈ {r}_{i}} D ( {Fcross}_{i}^{( m ) - ( b )} , 0 ) + {\sum }_{j ∈ {r}_{j}} D ( {Fcross}_{i}^{( m ) - ( b )} , 1 ) ) ) \qquad ( 9 )$$

where rᵢ∈[1, 2, . . . , indi] indicates the first indi segments of the piecewise function; and rⱼ∈[I−indj, . . . , I−1, I] indicates the last indj+1 segments of the piecewise function. Values of indi and indj may be set and adjusted according to an actual application scenario, and the values are different in different application scenarios. This is not specifically limited herein. For example, in some scenarios, indi=10, and indj=4. In some other scenarios, indi=10, and indj=2.

Further, according to the consistency loss function in the formula (8) and the constraint loss function in the formula (9), the following objective function is constructed:

$$L = λ {L}_{consistency} + {L}_{contraint} \qquad ( 10 )$$

In the formula (10), λ is a preset weight parameter, used for balancing the consistency loss and the constraint loss. A value of λ may be set according to an empirical value, and is not specifically limited herein. The value may be different in different application scenarios, for example, may be 80, 20, 2, etc. Meanings of other characters are the same as those in the foregoing content, and details are not described herein again.

In an embodiment, the objective function may be constructed based on only the foregoing constraint loss function.

Step S3043: Minimize the objective function by using the optimization algorithm according to the similarities of the plurality of sample pairs in each modality, to solve and obtain the segment parameters.

After the objective function is constructed, segment parameters enabling the objective function to have a minimum value is solved by using an optimization algorithm and according to the similarities of the plurality of sample pairs in each modality, which may be specifically implemented by using any optimization algorithm among a gradient descent method, a Newton method, a quasi-Newton method, a momentum optimization method, a conjugate gradient method, and a heuristic optimization algorithm. This is not specifically limited herein.

Step S3044: Substitute the segment parameters into the piecewise function to obtain the posterior matching probability function in each modality.

After the segment parameters are obtained through solving, the segment parameters are substituted into the piecewise function to obtain the posterior matching probability function in each modality.

In another implementation of step S304, the posterior matching probability function in each modality may alternatively be initialized to a continuous monotonous function, where the continuous monotonous function includes a to-be-solved unknown parameter. A consistency loss function and a constraint loss function are constructed based on the continuous monotonous function, and the objective function is constructed. The unknown parameter is obtained through solving by minimizing the objective function by using an optimization algorithm, to obtain a continuous monotonous posterior matching probability function in each modality.

After the posterior matching probability function in each modality is learned, step S203 is implemented by using steps S305 and S306 to calculate a posterior matching probability of any two target objects in multimodality according to the posterior matching probability function in each modality.

Step S305: Determine, according to the similarity between any two target objects in any modality, a posterior matching probability of the any two target objects in the modality by using the posterior matching probability function in the modality.

After the posterior matching probability function in each modality is obtained, for any modality, using the mth modality as an example, according to a similarity between any two target objects in the modality, in the independent variables

$$\{ {x}_{1}^{( m )} , {x}_{2}^{( m )} , … , {x}_{I}^{( m )} \}$$

of I segments of the posterior matching probability function in the modality, an independent variable having the minimum absolute difference with the similarity of the two target objects is determined, and a posterior matching probability value corresponding to the independent variable is used as a posterior matching probability of the two target objects in the modality. Similarly, the posterior matching probability of any two target objects in each modality can be determined.

Step S306: Calculate a posterior matching probability of any two target objects in multimodality according to the posterior matching probability of the any two target objects in each modality.

In this step, after the posterior matching probability of any two target objects in each modality is calculated, a posterior matching probability P(i, j) of the any two target objects i and j in multimodality may be calculated by using the following formula (11):

$$P ( i , j ) = \frac{{\prod }_{m = 1}^{M} P ( {e}_{i j} = 1 \vert {w}_{ij}^{( m )} )}{{\prod }_{m = 1}^{M} P ( {e}_{i j} = 1 \vert {w}_{i j}^{( m )} ) + {\prod }_{m = 1}^{M} P ( {e}_{i j} = 0 \vert {w}_{ij}^{( m )} )} where \qquad ( 11 )$$

$$P ( {e}_{ij} = 1 \vert {w}_{ij}^{( m )} )$$

represents a posterior matching probability of the target objects i and j in the m^{th} modality, and

$$P ( {e}_{ij} = 0 \vert {w}_{ij}^{( m )} ) = 1 - P ( {e}_{ij} = 1 \vert {w}_{ij}^{( m )} ) .$$

Meanings of other characters are the same as those in the foregoing content, and details are not described herein again.

In an implementation, in this step, an average value of posterior matching probabilities of the any two target objects in the modalities may be calculated as the posterior matching probability of the two target objects in multimodality. In an implementation, in this step, posterior matching probabilities of any two target objects in the modalities may be weighted to obtain an average value according to weight coefficients corresponding to the modalities, and a calculation result is used as the posterior matching probability of the two target objects in multimodality.

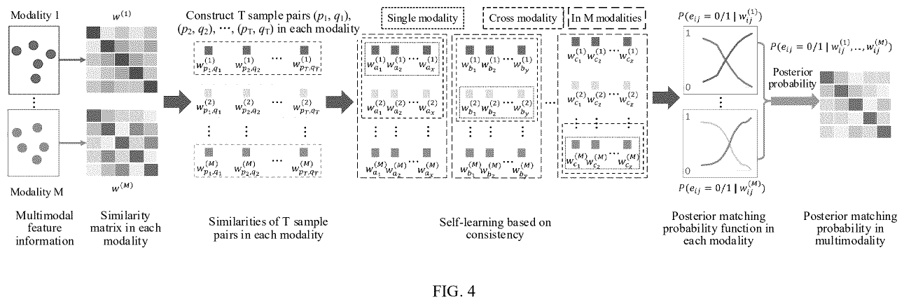

For example, FIG. 4 is a framework diagram of determining a posterior matching probability of target objects in multimodality based on multimodal information according to this embodiment. As shown in FIG. 4, feature information of the target objects in M modalities is first obtained. For any modality, a similarity between feature information of any two target objects in the modality is calculated, to obtain similarity matrices w⁽¹⁾, . . . , and w^{(M)} of the modalities. According to the similarity matrices w⁽¹⁾, . . . , and w^{(M)} of the modalities, T sample pairs (p₁, q₁), (p₂, q₂), . . . , and (p_{T}, q_{T}) in each modality are constructed by using a KNN algorithm, and similarities of the T sample pairs are determined, for example, in the m^{th} modality, a similarity of (p₁, q₁) may be represented in a form of

$${w}_{{p}_{1 ,} {q}_{1}}^{( 1 )} .$$

The T sample pairs in each modality are sorted according to similarities, and then divided into I segment sets, where aₓ, b_{y}, . . . , and c_{z} respectively represent a quantity of sample pairs in the I segment sets;

$${w}_{{a}_{1}}^{( 1 )} , {w}_{{a}_{2}}^{( 1 )} , … , and {w}_{{a}_{x}}^{( 1 )}$$

respectively represent similarities of aₓ sample pairs in the first segment set in the first modality;

$${w}_{{b}_{1}}^{( 1 )} , {w}_{{b}_{2}}^{( 1 )} , … , and {w}_{{b}_{y}}^{( 1 )}$$

respectively represent similarities of b_{y} sample pairs in the second segment set in the first modality; and

$${w}_{{c}_{1}}^{( 1 )} , {w}_{{c}_{2}}^{( 1 )} , … , and {w}_{{c}_{z}}^{( 1 )}$$

respectively represent similarities of c_{z} sample pairs in the last segment set in the first modality. Representation forms of similarities of sample pairs in segment sets in another modality are similar thereto, for example,

$${w}_{{a}_{1}}^{( 2 )} , {w}_{{a}_{2}}^{( 2 )} , … , and {w}_{{a}_{x}}^{( 2 )}$$

respectively represent similarities of aₓ sample pairs in the first segment set in the second modality. This is not listed one by one herein. The posterior matching probability function in each single modality is initialized to a piecewise function, a cross posterior matching probability function of two modalities (that is, cross-modality) and a posterior matching probability function of the M modalities are constructed based on the piecewise functions, and the posterior matching probability function in each modality is generated through self-learning based on consistency of various types of posterior matching probability functions. Based on the posterior matching probability function in each modality and a similarity between any two target objects in each modality, a posterior matching probability of the any two target objects in each single modality may be calculated. Further, based on the posterior matching probability of the any two target objects in each single modality, a posterior matching probability of the any two target objects in multimodality may be calculated, as a final posterior matching probability of the two target objects in multimodality. Further, a clustering result of the target objects may be obtained by performing clustering based on the final posterior matching probability of the two target objects.

In an embodiment, after the posterior matching probability of any two target objects in multimodality is calculated according to the posterior matching probability function in each modality, the following steps S307 and S308 may be further performed to optimize the posterior matching probability of the any two target objects in multimodality, to improve accuracy of the posterior matching probability of the any two target objects in multimodality.

Step S307: Determine, for any two target objects, K nearest neighbor objects of the two target objects in each modality, and determine a shared nearest neighbor object of the two target objects.

In this step, the K nearest neighbor objects of any target object in any modality are obtained by determining, based on similarities between other target objects and the target object in the modality, K target objects having high similarities with the target object by using a KNN algorithm. K may be set and adjusted according to a requirement of an actual application scenario, which is not specifically limited herein. K is a positive integer.

Further, after K nearest neighbor objects of each target object in each modality are determined, a union set of K nearest neighbor object sets of any target object in respective modalities may be obtained, and the union set is used as a nearest neighbor object set of the target object, including the K nearest neighbor objects of the target object in each modality. For any two target objects, an intersection set of nearest neighbor object sets of the two target objects is determined, and a nearest neighbor object in the intersection set is a shared nearest neighbor object of the two target objects.

For example,

$${knn}_{i}^{( m )}$$

represents a set of K nearest neighbor objects of a target object i in the m^{th} modality, and a nearest neighbor object set of the target object i is a union set of

$${knn}_{i}^{( 1 )} , {knn}_{i}^{( 2 )} , … , and {knn}_{i}^{( M )} ,$$

which may be represented as

$${knn}_{i} = \{ ⋃ {knn}_{i}^{( m )} \} .$$

### Similarly,

$${knn}_{j}^{( m )}$$

represents a set of K nearest neighbor objects of a target object j in the mth modality, and a nearest neighbor object set of the target object j is represented as

$${knn}_{j} = \{ ⋃ {knn}_{j}^{( m )} \} .$$

A set of shared nearest neighbor objects of the target object i and the target object j is knnᵢⱼ=knnᵢ∩knnⱼ.

Step S308: Optimize the posterior matching probability of the two target objects in multimodality according to posterior matching probabilities of the two target objects and the same shared nearest neighbor object in multimodality.

In this embodiment, the posterior matching probability of any two target objects in multimodality is optimized according to posterior matching probabilities of the two target objects and a same shared nearest neighbor object in multimodality and base on consistency and a boundary constraint of the posterior matching probability, to improve the accuracy of the posterior matching probability of any two target objects in multimodality.

A first optimization manner applicable to this step is: calculating a product of the posterior matching probabilities of the two target objects and the same shared nearest neighbor object in multimodality, and optimizing the posterior matching probability of the two target objects in multimodality according to a maximum value of the product and the posterior matching probability of the two target objects in multimodality.

For example, for a posterior matching probability P(i, j) of any two target objects i and j in multimodality obtained through computation, the following formula (12) may be used for optimization:

$$P ( i , j ) = max ( P ( i , j ) , P ( i , h ) \times P ( h , j ) ) \qquad ( 12 )$$

In the formula (12), h refers to any shared nearest neighbor object of the target object i and the target object j, and h∈knnᵢⱼ. knnᵢⱼ=knnᵢ∩knnⱼ represents a set of shared nearest neighbor objects of the target object i and the target object j. max ( ) is a function for obtaining the maximum value. Meanings of other characters are the same as those in the foregoing content, and details are not described herein again.

A second optimization manner applicable to this step is: using a sum of the posterior matching probabilities of the two target objects and the same shared nearest neighbor object in multimodality as a posterior matching probability sum corresponding to the shared nearest neighbor object; calculating a sum of posterior matching probability sums corresponding to shared nearest neighbor objects to obtain a first summation result; for a first object and a second object of the two target objects, calculating a sum of posterior matching probabilities of the first object and the nearest neighbor objects of the first object in multimodality to obtain a second summation result, calculating a sum of posterior matching probabilities of the second object and the nearest neighbor objects of the second object in multimodality to obtain a third summation result, and calculating a sum of the second summation result and the third summation result to obtain a fourth summation result; and optimizing the posterior matching probability of the two target objects in multimodality according to a ratio of the first summation result to the fourth summation result.

For example, for a posterior matching probability P(i, j) of any two target objects i and j in multimodality obtained through computation, the following formula (13) may be used for optimization:

$$P ( i , j ) = \frac{{\sum }_{h ∈ {knn}_{ij}} ( P ( i , h ) + P ( h , j ) )}{{\sum }_{{h}_{i} ∈ {knn}_{i}} P ( i , {h}_{i} ) + {\sum }_{{h}_{j} ∈ {knn}_{j}} P ( j , {h}_{j} )} \qquad ( 13 )$$

In the formula (13), hᵢ refers to any nearest neighbor object in a nearest neighbor object set of the target object i, and hᵢ∈knnᵢ. hⱼ refers to any nearest neighbor object in a nearest neighbor object set of the target object j, and hⱼ∈knnⱼ. Meanings of other characters are the same as those in the foregoing content, and details are not described herein again.

In this step, the foregoing two optimization manners may further be used to optimize the posterior matching probability of any two target objects in multimodality, and a sequence of performing optimization based on the two optimization manners is not limited. For example, the posterior matching probability of any two target objects in multimodality may be first optimized by using the first optimization manner, and then an optimization result of the first optimization manner is optimized for the second time by using the second optimization manner. Alternatively, the posterior matching probability of any two target objects in multimodality may be first optimized by using the second optimization manner, and then an optimization result of the second optimization manner is optimized for the second time by using the first optimization manner.

Step S309: Cluster the target objects according to the posterior matching probability of any two target objects in multimodality to generate a clustering result of the target objects.

After the posterior matching probability of any two target objects in multimodality is obtained, the target objects are clustered based on the posterior matching probability of any two target objects in multimodality, to generate the clustering result of the target objects.

In this step, any existing clustering algorithm may be used, and the posterior matching probability of the target objects in multimodality is used as a metric distance for the similarity between the target objects, to perform clustering. A specific clustering procedure is not described herein again.

In this embodiment, for any two target objects, when feature information of the target objects in one or more modalities is missing, the feature information in the modality (modalities) may be ignored, and the posterior matching probability of the two target objects in remaining multiple modalities is calculated based on feature information of each modality in which no information is missing, so that when feature information in some modalities is missing, clustering can still be accurately performed without supplementing the feature information in the missing modalities. In addition, multimodal feature information is fully used for clustering, importance between different modalities is focused on, and the accuracy and recall rate of the clustering are improved. In addition, T sample pairs in each modality are constructed by using the KNN algorithm, and a posterior matching probability function in each modality is generated through self-learning based on similarities of the T sample pairs in each modality, so that time for generating the posterior matching probability function in each modality through self-learning can be shortened, thereby improving clustering efficiency.

The multimodal information-based clustering method provided in this application can generate the posterior matching probability function in each single modality through self-learning, thereby enabling unbiased and rapid application to different data distribution scenarios, for example, aggregation and collation of different regional image libraries and clustering of commodities of a same type.

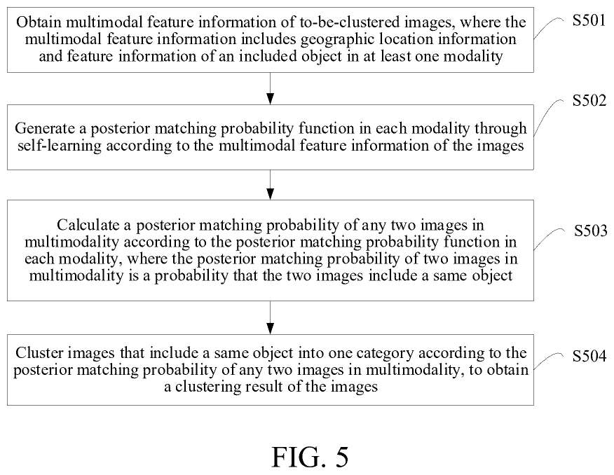

FIG. 5 is a flowchart of a multimodal information-based clustering method according to another exemplary embodiment of this application. The method provided in this embodiment is applicable to a scenario of clustering and collating different regional image libraries. For images in different regional information libraries captured in different regions, images that belong to a same object are clustered to a same cluster based on geographic location information of image capturing and feature information that is in at least one modality and of an object included in the images. For example, based on images captured in different regions, multimodal clustering is performed on images based on geographic location information of image capturing, and biometric features of persons included in the images, to aggregate images of a same person to a same cluster. For example, based on motor vehicle images captured in different regions, multimodal clustering is performed on motor vehicle images based on geographic location information of motor vehicle image capturing, license plate numbers, owner identities, and appearance features of motor vehicles included in the motor vehicle images, and the like, to aggregate images of a same motor vehicle into a same cluster.

As shown in FIG. 5, the method specifically includes the following steps.

Step S501: Obtain multimodal feature information of to-be-clustered images, where the multimodal feature information includes geographic location information and feature information of an included object in at least one modality.

The to-be-clustered target objects in this embodiment are images, and multimodal feature information of the images includes geographic location information of image capturing, and feature information of an object included in the images in at least one modality.

For example, in a scenario of clustering and collating different regional image libraries, the to-be-clustered images may be images of a particular object captured in different regions in a plurality of regional information libraries. Using a human image as an example, multimodal feature information of the image may include location coordinates of image capturing, and features of a human included in the image in at least one of the following modalities: a biological feature, a gait feature, and identity information.

Step S502: Generate a posterior matching probability function in each modality through self-learning according to the multimodal feature information of the images.

After the multimodal feature information of the to-be-clustered images is obtained, the posterior matching probability function in each modality is generated through self-learning according to the multimodal feature information of the images. This step may be implemented in a manner similar to step S202 in any one of the foregoing method embodiments. The target object in this step is an image. For details, refer to related content in the foregoing embodiments, and details are not described herein again.

Step S503: Calculate a posterior matching probability of any two images in multimodality according to the posterior matching probability function in each modality, where the posterior matching probability of two images in multimodality is a probability that the two images include a same object.

A specific implementation of this step is similar to the implementation of calculating a posterior matching probability of any two target objects in multimodality according to the posterior matching probability function in each modality in the foregoing step S203. The target object in this step is an image. For details, refer to related content in the foregoing embodiments, and details are not described herein again.

Step S504: Cluster images that include a same object into one category according to the posterior matching probability of any two images in multimodality, to obtain a clustering result of the images.

After the posterior matching probability of any two images in multimodality is obtained, the images are clustered based on the posterior matching probability of any two images in multimodality, images having a larger posterior matching probability in multimodality are clustered into a same cluster, and images having a smaller posterior matching probability in multimodality are clustered into different clusters, thereby implementing accurate image clustering based on uniqueness of the objects included in the images.

In this step, any existing clustering algorithm may be used, and the posterior matching probability of the images in multimodality is used as a metric distance for the similarity between the images, to perform clustering. A specific clustering procedure is not described herein again.

Further, after obtaining the image clustering result, the server sends the image clustering result to the terminal side device, and the terminal side device may execute at least one of the following processing logics according to the image clustering result: information pushing, information searching, or data classification. In another implementation, the server may execute at least one of the following processing logics according to the image clustering result: information pushing, information searching, or data classification, and send an execution result to the terminal side device.

For example, after obtaining the image clustering result, the server may associate, according to the clustering result, in accordance with clusters to which the images belong, images of a same cluster with an included object, and store the images by classification, to implement the function of information library aggregation and collation.

For example, after obtaining the image clustering result, the server may further analyze and determine information such as a movement range and a social area of a specified object based on geographic location information of images associated with the specified object.

In this embodiment, in a scenario of aggregation and collation of different regional information libraries, geographic location information of to-be-clustered images and feature information of an included object in at least one modality are obtained to obtain multimodal feature information of the to-be-clustered images. A posterior matching probability function in each single modality is generated through self-learning, so that the posterior matching probability function in each modality can be automatically learned without using annotation information; a posterior matching probability of any two images in multimodality is calculated according to the posterior matching probability function in each single modality; and the images are clustered according to the posterior matching probability of any two images in multimodality, to generate a clustering result of the images. The posterior matching probability that the images include a same object is calculated based on the multimodal feature information of the images by using the posterior matching probability function generated through self-learning, and is used as a metric distance for the similarity between the images. In comparison with using the Euclidean distance or the cosine similarity between image features in mainstream methods, using the posterior matching probability between the images can measure the similarity between objects included in the images more accurately. Clustering is performed based on the posterior matching probability between the images, which can greatly improve the accuracy and recall rate of the image clustering.

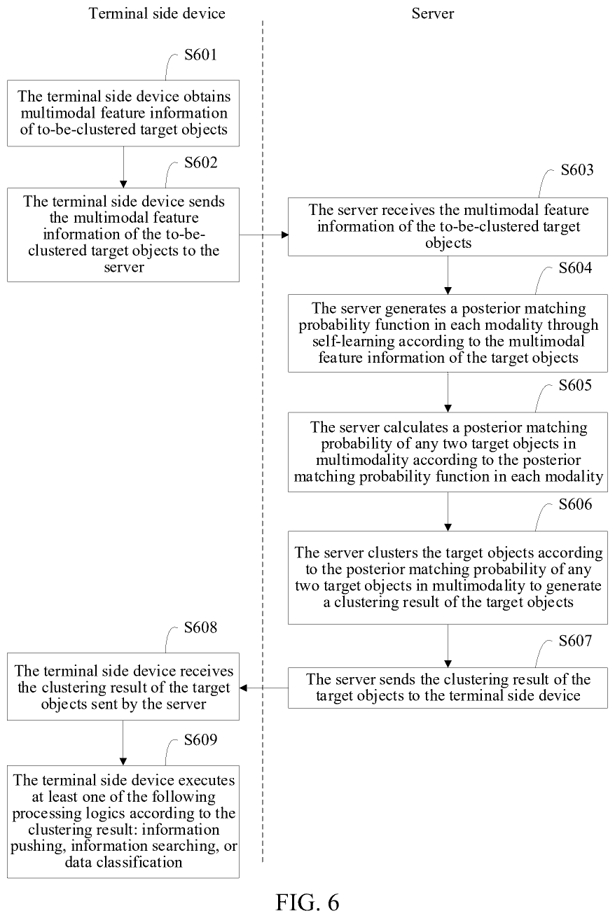

FIG. 6 is an interaction diagram of a multimodal information-based clustering method according to an exemplary embodiment of this application. As shown in FIG. 6, in the multimodal information-based clustering method, an interaction procedure between a server and a terminal side device is as follows.

Step S601: The terminal side device obtains multimodal feature information of to-be-clustered target objects.

In this embodiment, the terminal side device obtains multimodal data of the target objects from a data service device. Data in different modalities may be from different devices. The multimodal data of the target objects is preprocessed to generate multimodal feature information of the target objects, and the multimodal feature information of the target objects is sent to the server.

The preprocessing the multimodal data of the target objects may include, but is not limited to, cleaning of dirty data, feature extraction, and the like. Feature information that is required to be obtained varies in different application scenarios, and manners of data preprocessing and feature extraction may be set according to requirements in actual application scenarios. Extraction manners for various types of feature information may be implemented by using common technologies for extracting same types of features, and details are not repeated here.

Step S602: The terminal side device sends the multimodal feature information of the to-be-clustered target objects to the server.

Step S603: The server receives the multimodal feature information of the to-be-clustered target objects.

Step S604: The server generates a posterior matching probability function in each modality through self-learning according to the multimodal feature information of the target objects.

A specific implementation of this step is the same as the specific implementation of the foregoing step S202. For details, refer to the related content in the foregoing embodiment, which are not herein described again.

Step S605: The server calculates a posterior matching probability of any two target objects in multimodality according to the posterior matching probability function in each modality.

A specific implementation of this step is the same as the specific implementation of the foregoing step S203. For details, refer to the related content in the foregoing embodiment, which are not herein described again.

Step S606: The server clusters the target objects according to the posterior matching probability of any two target objects in multimodality to generate a clustering result of the target objects.

A specific implementation of this step is the same as the specific implementation of the foregoing step S204. For details, refer to the related content in the foregoing embodiment, which are not herein described again.

Step S607: The server sends the clustering result of the target objects to the terminal side device.

Step S608: The terminal side device receives the clustering result of the target objects sent by the server.

Step S609: The terminal side device executes at least one of the following processing logics according to the clustering result: information pushing, information searching, or data classification.

For example, in an e-commerce scenario, after an item clustering result is obtained by clustering similar items of different merchants to a same cluster through multimodal clustering, services such as item searching and item recommendation may be implemented based on multimodal information such as videos, pictures, introduction texts, and price information.

For example, according to an item currently browsed by a user, information about similar items are searched for, and the information about the similar items is presented/pushed to the user to facilitate the user's selection of desired items. Alternatively, according to an image submitted by a user, an item included in the image and information about similar items thereof are searched for, and the item included in the image and the information about similar items thereof are presented/pushed to the user to facilitate the user's selection of desired items.

For example, in a scenario of clustering and collating different regional information libraries, among the images captured in different regions, images that belong to a same object are clustered to a same cluster based on geographic location information of image capturing and feature information of objects included in the images in at least one modality. Further, according to a clustering result, images of a same cluster are associated with the included object according to the cluster to which the images belong, and the images are stored by classification to implement the function of information library aggregation and collation.

This embodiment provides the interaction procedure between the server and the terminal side device in the multimodal information-based clustering method.

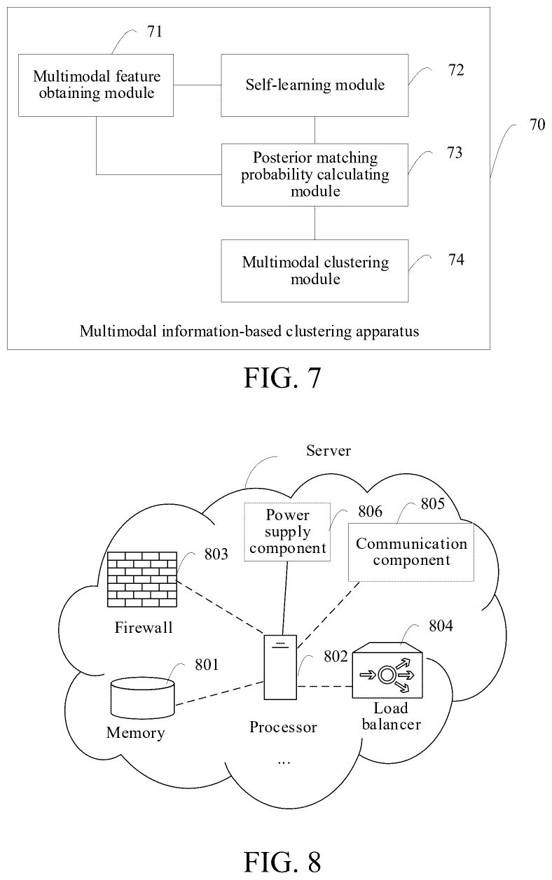

FIG. 7 is a schematic structural diagram of a multimodal information-based clustering apparatus according to an exemplary embodiment of this application. The multimodal information-based clustering apparatus provided in this embodiment of this application can execute the processing procedure provided in the multimodal information-based clustering method embodiment. As shown in FIG. 7, the multimodal information-based clustering apparatus 70 includes: a multimodal feature obtaining module 71, a self-learning module 72, a posterior matching probability calculating module 73, and a multimodal clustering module 74.

Specifically, the multimodal feature obtaining module 71 is configured to obtain multimodal feature information of to-be-clustered target objects.

The self-learning module 72 generates a posterior matching probability function in each modality through self-learning according to the multimodal feature information of the target objects.

The posterior matching probability calculating module 73 calculates a posterior matching probability of any two target objects in multimodality according to the posterior matching probability function in each modality.

The multimodal clustering module 74 clusters the target objects according to the posterior matching probability of any two target objects in multimodality, to generate a clustering result of the target objects.

In an embodiment, when implementing generating the posterior matching probability function in each modality through self-learning according to the multimodal feature information of the target objects, the self-learning module 72 is further configured to:
calculate a similarity between any two target objects in a same modality according to feature information of the target objects in the same modality; construct a plurality of sample pairs in each modality according to a similarity between any two target objects in each modality, where the sample pair includes two target objects; and generate the posterior matching probability function in each modality through self-learning by using an optimization algorithm and according to similarities of the plurality of sample pairs in each modality.

In an embodiment, when implementing constructing the plurality of sample pairs in each modality according to the similarity between any two target objects in each modality, where the sample pair includes two target objects, the self-learning module 72 is further configured to:
determine, for any modality, K nearest neighbor objects of each of the target objects in the modality according to a similarity between any two target objects in the modality, where K is a positive integer; and form a sample pair by using each of the target objects and the K nearest neighbor objects in the modality respectively, to obtain a plurality of sample pairs in the modality.

In an embodiment, when implementing generating the posterior matching probability function in each modality through self-learning by using the optimization algorithm and according to the similarities of the plurality of sample pairs in each modality, the self-learning module 72 is further configured to:
initialize the posterior matching probability function in each modality to a monotonically increasing piecewise function, where the piecewise function includes to-be-solved piecewise parameters; construct an objective function based on the posterior matching probability function in each modality, where the objective function includes the to-be-solved piecewise parameters; minimize the objective function by using the optimization algorithm and according to the similarities of the plurality of sample pairs in each modality to solve and obtain the segment parameters; and substitute the segment parameters into the piecewise function to obtain the posterior matching probability function in each modality.

In an embodiment, when implementing constructing the objective function based on the posterior matching probability function in each modality, the self-learning module 72 is further configured to:
construct a posterior matching probability function in multimodality according to the posterior matching probability function in each modality; construct a consistency loss function and a constraint loss function according to the posterior matching probability function in each modality and the posterior matching probability function in multimodality; and
construct the objective function according to the consistency loss function and the constraint loss function.

In an embodiment, when implementing calculating the posterior matching probability of any two target objects in multimodality according to the posterior matching probability function in each modality, the posterior matching probability calculating module 73 is further configured to:
determine, according to a similarity between any two target objects in any modality, a posterior matching probability of the any two target objects in the modality by using a posterior matching probability function in the modality; and calculate the posterior matching probability of the any two target objects in multimodality according to the posterior matching probability of the any two target objects in each modality.

In an embodiment, after calculating the posterior matching probability of any two target objects in multimodality according to the posterior matching probability function in each modality, the posterior matching probability calculating module 73 is further configured to:
determine, for any two target objects, K nearest neighbor objects of the two target objects in each modality, and determine a shared nearest neighbor object of the two target objects, where K is a positive integer; and optimize a posterior matching probability of the two target objects in multimodality according to posterior matching probabilities of the two target objects and a same shared nearest neighbor object in multimodality.

In an embodiment, when implementing optimizing the posterior matching probability of the two target objects in multimodality according to the posterior matching probabilities of the two target objects and the same shared nearest neighbor object in multimodality, the posterior matching probability calculating module 73 is further configured to:
calculate a product of the posterior matching probabilities of the two target objects and the same shared nearest neighbor object in multimodality, and optimize the posterior matching probability of the two target objects in multimodality according to a maximum value of the product and the posterior matching probability of the two target objects in multimodality.

In an embodiment, when implementing optimizing the posterior matching probability of the two target objects in multimodality according to the posterior matching probabilities of the two target objects and the same shared nearest neighbor object in multimodality, the posterior matching probability calculating module 73 is further configured to:
use a sum of posterior matching probabilities of the two target objects and the same shared nearest neighbor object in multimodality as a posterior matching probability sum corresponding to the shared nearest neighbor object; calculate a sum of posterior matching probability sums corresponding to shared nearest neighbor objects to obtain a first summation result; for a first object and a second object of the two target objects, calculate a sum of posterior matching probabilities of the first object and the nearest neighbor objects of the first object in multimodality to obtain a second summation result; calculate a sum of posterior matching probabilities of the second object and the nearest neighbor objects of the second object in multimodality to obtain a third summation result; and calculate a sum of the second summation result and the third summation result to obtain a fourth summation result; and optimize the posterior matching probability of the two target objects in multimodality according to a ratio of the first summation result to the fourth summation result.

In an embodiment, when implementing obtaining of the multimodal feature information of to-be-clustered target objects, the multimodal feature obtaining module 71 is further configured to receive the multimodal feature information of the to-be-clustered target objects sent by a terminal side device.

After generating the clustering result of the target objects, the multimodal clustering module 74 is further configured to output the clustering result of the target objects to the terminal side device.

The apparatus provided in this embodiment of this application may be specifically configured to perform the processing procedure performed by the server in any one of the foregoing method embodiments. A specific function and a technical effect that can be achieved are not described herein again.

FIG. 8 is a schematic structural diagram of a server according to an embodiment of this application. As shown in FIG. 8, the server includes a memory 801 and a processor 802. The memory 801 is configured to store computer-executable instructions, and may be configured to store various other data to support operations on the server. The processor 802 is communicatively connected to the memory 801 and is configured to execute the computer-executable instructions stored in the memory 801 to implement the technical solutions provided in any one of the foregoing method embodiments. Specific functions and technical effects that can be implemented are similar, and details are not described herein again. In FIG. 8, an example in which the server is a cloud server is used for description, and the server may alternatively be a locally deployed server.

In an implementation, as shown in FIG. 8, the server further includes other components such as a firewall 803, a load balancer 804, a communication component 805, and a power supply component 806. Only some components are schematically provided in FIG. 8, and it does not mean that the server includes only the components shown in FIG. 8.

An embodiment of this application further provides a computer-readable storage medium. The computer-readable storage medium has computer-executable instructions stored therein, and the computer-executable instructions, when executed by a processor, are used to implement the solution provided in any one of the foregoing method embodiments. Specific functions and technical effects that can be implemented are not described here again.

An embodiment of this application further provides a computer program product. The computer program product includes a computer program. The computer program is stored in a readable storage medium. At least one processor of a server may read the computer program from the readable storage medium, and at least one processor executes the computer program, so that the server executes the solution provided in any one of the foregoing method embodiments. Specific functions and technical effects that can be implemented are not described here again. An embodiment of this application provides a chip, including: a processing module and a communication interface. The processing module can execute the technical solution of the server in the foregoing method embodiments. In an implementation, the chip further includes a storage module (for example, a memory). The storage module is configured to store instructions, the processing module is configured to execute the instructions stored in the storage module, and execution of the instructions stored in the storage module causes the processing module to perform the technical solution provided in any one of the foregoing method embodiments.

The memory may be an object storage service (OSS).

The memory may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The communication component is configured to facilitate wired or wireless communication between a device on which the communication component is located and another device. The device on which the communication component is located may access a wireless network based on a communication standard, such as a mobile communication network such as a mobile hotspot (Wi-Fi), a second generation mobile communication system (2G), a third generation mobile communication system (3G), a fourth generation mobile communication system (4G)/long term evolution (LTE), or a fifth generation mobile communication system (5G), or a combination thereof. In an exemplary embodiment, the communication component receives a broadcast signal or broadcast related information from an external broadcast management system through a broadcast channel. In an exemplary embodiment, the communication component further includes a near field communication (NFC) module to facilitate short range communication. For example, the NFC module may be implemented based on a radio frequency identification (RFID) technology, an infrared data association (IrDA) technology, an ultra-wideband (UWB) technology, a Bluetooth (BT) technology, and other technologies.

The power supply component supplies power to various components of the device on which the power supply component is located. The power supply component may include a power supply management system, one or more power supplies, and other components associated with generating, managing, and allocating power for the device on which the power supply component is located.

A person skilled in the art should understand that the embodiments of the present disclosure may be provided as a method, a system, or a computer program product. Therefore, the present disclosure may use a form of hardware-only embodiments, software-only embodiments, or embodiments with a combination of software and hardware. Moreover, the present disclosure may use a form of a computer program product that is implemented on one or more computer-usable storage media (including but not limited to a disk memory, a compact disc read-only memory (CD-ROM), an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a special-purpose computer, an embedded processor, or a processor of any other programmable data processing device to generate a machine, so that the instructions executed by the computer or the processor of any other programmable data processing device generate an apparatus for implementing a specific function in one or more procedures in the flowcharts and/or in one or more blocks in the block diagrams.

These computer program instructions may alternatively be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operational steps are performed on the computer or the another programmable device, thereby generating computer-implemented processing. Therefore, the instructions executed on the computer or the another programmable device provide operations for implementing a specific function in one or more procedures in the flowcharts and/or in one or more blocks in the block diagrams.

In a typical configuration, a computing device includes one or more processors (CPUs), an input/output interface, a network interface, and a memory.

The memory may include a form such as a volatile memory, a random-access memory (RAM) and/or a non-volatile memory such as a read-only memory (ROM) or a flash RAM in computer-readable media. The memory is an example of a computer-readable medium.

The computer-readable medium includes a non-volatile medium and a volatile medium, a removable medium and a non-removable medium, which may implement storage of information by using any method or technology. The information may be a computer-readable instruction, a data structure, a program module, or other data. Examples of a storage medium of a computer includes, but is not limited to, a phase-change memory (PRAM), a static random access memory (SRAM), a dynamic random access memory (DRAM), or other types of random access memory (RAM), a read-only memory (ROM), an erasable programmable read-only memory (EEPROM), a flash memory or another storage technology, a compact disc read-only memory (CD-ROM), a digital versatile disc (DVD) or another optical storage, a cartridge tape, a magnetic tape, a magnetic disk storage or another magnetic storage device, or any other non-transmission medium, which may be configured to store information accessible by a computing device. According to limitations of this specification, the computer-readable medium does not include transitory computer-readable media (transitory media), such as a modulated data signal and a modulated carrier.

It should be noted that, user information (including but not limited to user equipment information, user attribute information, and the like) and data (including but not limited to data for analysis, stored data, displayed data, and the like) in this application are all information and data that are authorized by a user or that are fully authorized by all parties, and related data needs to be collected, used, and processed by complying with relevant laws, regulations, and standards. In addition, a corresponding operation entry is provided for the user to select to authorize or reject.

In addition, some procedures described in the foregoing embodiments and accompanying drawings include a plurality of operations performed in a particular order. However, it should be clearly learned that these operations may not be performed in the order in which these operations are performed in the specification or may be performed concurrently. The sequence numbers are merely used to distinguish between different operations, and do not represent any execution order. In addition, these procedures may include more or fewer operations, and these operations may be performed in an order or may be performed concurrently. It should be noted that, descriptions of “first”, “second”, and the like in the specification are used to distinguish between different messages, devices, modules, and the like, and do not indicate a sequence and do not limit that “first” and “second” are different types either. “A plurality of” means two or more, unless otherwise explicitly and specifically defined.

It should be noted that, user information (including but not limited to user equipment information, user personal information, and the like) and data (including but not limited to data for analysis, stored data, displayed data, and the like) in this application are all information and data that are authorized by a user or that are fully authorized by all parties, and related data needs to be collected, used, and processed by complying with relevant laws, regulations, and standards. In addition, a corresponding operation entry is provided for the user to select to authorize or reject.

After considering the specification and practicing the present disclosure, a person skilled in the art may easily conceive of other implementations of this application. This application is intended to cover any variations, uses, or adaptive changes of this application. These variations, uses, or adaptive changes follow the general principles of this application and include common general knowledge or common technical means in the art, which are not disclosed in this application. The specification and the embodiments are considered as merely illustrative, and the scope and spirit of this application are indicated in the following claims.

It should be understood that this application is not limited to the precise structures described above and shown in the accompanying drawings, and various modifications and changes can be made without departing from the scope of this application. The scope of this application is subject only to the appended claims.

1. A multimodal information-based clustering method, comprising:
obtaining multimodal feature information of to-be-clustered target objects;
generating a posterior matching probability function in each modality through self-learning according to the multimodal feature information of the target objects;
calculating a posterior matching probability of any two target objects in multimodality according to the posterior matching probability function in each modality; and
clustering the target objects according to the posterior matching probability of any two target objects in multimodality, to generate a clustering result of the target objects.

2. The method according to claim 1, wherein the generating the posterior matching probability function in each modality through self-learning according to the multimodal feature information of the target objects comprises:
calculating, according to feature information of the target objects in a same modality, a similarity between any two target objects in the same modality;
constructing a plurality of sample pairs in each modality according to a similarity between any two target objects in each modality, wherein each of the plurality of sample pairs comprises two target objects; and
generating the posterior matching probability function in each modality through self-learning by using an optimization algorithm and according to similarities of the plurality of sample pairs in each modality.

3. The method according to claim 2, wherein the constructing the plurality of sample pairs in each modality according to the similarity between any two target objects in each modality comprises:
determining, for any modality, K nearest neighbor objects of each of the target objects in the modality according to a similarity between any two target objects in the modality, wherein K is a positive integer; and
forming a sample pair by using each of the target objects and the K nearest neighbor objects in the modality respectively, to obtain a plurality of sample pairs in the modality.

4. The method according to claim 2, wherein the generating the posterior matching probability function in each modality through self-learning by using the optimization algorithm and according to the similarities of the plurality of sample pairs in each modality comprises:
initializing the posterior matching probability function in each modality to a monotonically increasing piecewise function, wherein the piecewise function comprises to-be-solved segment parameters;
constructing an objective function based on the posterior matching probability function in each modality, wherein the objective function comprises the to-be-solved segment parameters;
minimizing the objective function by using the optimization algorithm and according to the similarities of the plurality of sample pairs in each modality, to solve and obtain the segment parameters; and
substituting the segment parameters into the piecewise function to obtain the posterior matching probability function in each modality.

5. The method according to claim 4, wherein the constructing the objective function based on the posterior matching probability function in each modality comprises:
constructing a posterior matching probability function in multimodality according to the posterior matching probability function in each modality;
constructing a consistency loss function and a constraint loss function according to the posterior matching probability function in each modality and the posterior matching probability function in multimodality; and
constructing the objective function according to the consistency loss function and the constraint loss function.

6. The method according to claim 1, wherein the calculating the posterior matching probability of any two target objects in multimodality according to the posterior matching probability function in each modality comprises:
determining, according to a similarity between any two target objects in any modality, a posterior matching probability of the any two target objects in the modality by using a posterior matching probability function in the modality; and
calculating the posterior matching probability of the any two target objects in multimodality according to the posterior matching probability of the any two target objects in each modality.

7. The method according to claim 1, wherein after the calculating a posterior matching probability of any two target objects in multimodality according to the posterior matching probability function in each modality, the method further comprises:
determining, for any two target objects, K nearest neighbor objects of the two target objects in each modality, and determining a shared nearest neighbor object of the two target objects, wherein K is a positive integer; and
optimizing the posterior matching probability of the two target objects in multimodality according to posterior matching probabilities of the two target objects and a same shared nearest neighbor object in multimodality.

8. The method according to claim 7, wherein the optimizing the posterior matching probability of the two target objects in multimodality according to posterior matching probabilities of the two target objects and the same shared nearest neighbor object in multimodality comprises:
calculating a product of the posterior matching probabilities of the two target objects and the same shared nearest neighbor object in multimodality, and optimizing the posterior matching probability of the two target objects in multimodality according to a maximum value of the product and the posterior matching probability of the two target objects in multimodality.

9. The method according to claim 7, wherein the optimizing the posterior matching probability of the two target objects in multimodality according to posterior matching probabilities of the two target objects and the same shared nearest neighbor object in multimodality comprises:
using a sum of posterior matching probabilities of the two target objects and the same shared nearest neighbor object in multimodality as a posterior matching probability sum corresponding to the shared nearest neighbor object;
calculating a sum of posterior matching probability sums corresponding to shared nearest neighbor objects, to obtain a first summation result;
for a first object and a second object in the two target objects, calculating a sum of posterior matching probabilities of the first object and the nearest neighbor objects of the first object in multimodality, to obtain a second summation result; calculating a sum of posterior matching probabilities of the second object and the nearest neighbor objects of the second object in multimodality, to obtain a third summation result; and calculating a sum of the second summation result and the third summation result, to obtain a fourth summation result; and
optimizing the posterior matching probability of the two target objects in multimodality according to a ratio of the first summation result to the fourth summation result.

10. The method according to claim 1, wherein the obtaining the multimodal feature information of the to-be-clustered target objects comprises:
receiving the multimodal feature information of the to-be-clustered target objects sent by a terminal side device; and
after generating the clustering result of the target objects, the method further comprises:
outputting the clustering result of the target objects to the terminal side device.

11. A multimodal information-based clustering method, comprising:
obtaining multimodal feature information of to-be-clustered images, wherein the multimodal feature information comprises geographic location information and feature information of a comprised object in at least one modality;
generating a posterior matching probability function in each modality through self-learning according to the multimodal feature information of the images;
calculating a posterior matching probability of any two images in multimodality according to the posterior matching probability function in each modality, wherein the posterior matching probability of two images in multimodality is a probability that the two images comprise a same object; and
clustering images that comprise a same object into one category according to the posterior matching probability of any two images in multimodality, to obtain a clustering result of the images.

12. A multimodal information-based clustering method, applied to a terminal side device, and comprising:
obtaining multimodal feature information of to-be-clustered target objects;
sending the multimodal feature information of the to-be-clustered target objects to a server;
receiving a clustering result of the target objects sent by the server, wherein the clustering result of the target objects is generated by using the method according to claim 1; and
executing at least one of the following processing logics according to the clustering result: information pushing, information searching, or data classification.

13. A server, comprising:
a processor and a memory communicatively connected to the processor, wherein
the memory stores computer-executable instructions; and
the processor executes the computer-executable instructions stored in the memory to:
obtain multimodal feature information of to-be-clustered target objects;
generate a posterior matching probability function in each modality through self-learning according to the multimodal feature information of the target objects;
calculate a posterior matching probability of any two target objects in multimodality according to the posterior matching probability function in each modality; and
cluster the target objects according to the posterior matching probability of any two target objects in multimodality, to generate a clustering result of the target objects.

14. A non-transitory computer-readable storage medium, wherein the computer-readable storage medium has computer-executable instructions stored therein, and the computer-executable instructions, when executed by a processor, are used to implement the method according to claim 1.

15. The server according to claim 13, wherein the processor specifically executes the computer-executable instructions stored in the memory to:
calculate, according to feature information of the target objects in a same modality, a similarity between any two target objects in the same modality;
construct a plurality of sample pairs in each modality according to a similarity between any two target objects in each modality, wherein each of the plurality of sample pairs comprises two target objects; and
generate the posterior matching probability function in each modality through self-learning by using an optimization algorithm and according to similarities of the plurality of sample pairs in each modality.

16. The server according to claim 15, wherein the processor specifically executes the computer-executable instructions stored in the memory to:
determine, for any modality, K nearest neighbor objects of each of the target objects in the modality according to a similarity between any two target objects in the modality, wherein K is a positive integer; and
form a sample pair by using each of the target objects and the K nearest neighbor objects in the modality respectively, to obtain a plurality of sample pairs in the modality.

17. The server according to claim 15, wherein the processor specifically executes the computer-executable instructions stored in the memory to:
initialize the posterior matching probability function in each modality to a monotonically increasing piecewise function, wherein the piecewise function comprises to-be-solved segment parameters;
construct an objective function based on the posterior matching probability function in each modality, wherein the objective function comprises the to-be-solved segment parameters;
minimize the objective function by using the optimization algorithm and according to the similarities of the plurality of sample pairs in each modality, to solve and obtain the segment parameters; and
substitute the segment parameters into the piecewise function to obtain the posterior matching probability function in each modality.

18. The server according to claim 17, wherein the processor specifically executes the computer-executable instructions stored in the memory to:
construct a posterior matching probability function in multimodality according to the posterior matching probability function in each modality;
construct a consistency loss function and a constraint loss function according to the posterior matching probability function in each modality and the posterior matching probability function in multimodality; and
construct the objective function according to the consistency loss function and the constraint loss function.

19. The server according to claim 13, wherein the processor specifically executes the computer-executable instructions stored in the memory to:
determine, according to a similarity between any two target objects in any modality, a posterior matching probability of the any two target objects in the modality by using a posterior matching probability function in the modality; and
calculate the posterior matching probability of the any two target objects in multimodality according to the posterior matching probability of the any two target objects in each modality.

20. The server according to claim 13, wherein after the calculating a posterior matching probability of any two target objects in multimodality according to the posterior matching probability function in each modality, the processor further executes the computer-executable instructions stored in the memory to:
determine, for any two target objects, K nearest neighbor objects of the two target objects in each modality, and determine a shared nearest neighbor object of the two target objects, wherein K is a positive integer; and
optimize the posterior matching probability of the two target objects in multimodality according to posterior matching probabilities of the two target objects and a same shared nearest neighbor object in multimodality.
